(19) United States
(12) Patent Application Publication
(10) Pub. No.: US 2026/0321778 A1
(43) Pub. Date: Oct. 15, 2026

(54) BATTERY PACK FOR AN ELECTRIC VEHICLE

(71) Applicant: BOMBARDIER RECREATIONAL PRODUCTS INC., Valcourt (CA)

(72) Inventor: Christian DE GRAMMONT, Sherbrooke (CA)

(21) Appl. No.: 19/116,499

(22) PCT Filed: Sep. 25, 2023
(86) PCT No.: PCT/IB2023/059457

§ 371 Date: Mar. 28, 2025

Related U.S. Application Data
(60) Provisional application No. 63/411,953, filed on Sep. 30, 2022.

(51) Int. Cl. H01M 10/6554; H01M 10/613; H01M 10/625; H01M 10/643; H01M 10/6556; H01M 50/213; H01M 50/249; H01M 50/271

(52) U.S. Cl. CPC H01M 10/6554; H01M 10/613; H01M 10/625; H01M 10/643; H01M 10/6556; H01M 50/213; H01M 50/249; H01M 50/271

(57) ABSTRACT

A battery pack for an electric vehicle, the battery pack including a battery housing including: a housing body, a heat transfer channel operative to convey a heat transfer fluid therethrough; a plurality of battery cells disposed in the housing body; at least one heat transfer plate disposed between the plurality of battery cells and the at least one heat transfer channel; at least one layer of thermally conductive adhesive material disposed between the battery cells and the heat transfer plate; and at least one layer of dielectric material disposed between the battery cells and the heat transfer plate, the at least one dielectric layer being configured to electrically insulate the heat transfer plate from the battery cells, the battery cells being disposed in thermal communication with the heat transfer channel via the thermally conductive adhesive material and the heat transfer plate.

### CROSS-REFERENCE

The present application claims priority to U.S. Provisional Patent Application No. 63/411,953, entitled “Battery Pack for an Electric Vehicle,” filed on Sep. 30, 2022, the entirety of which is incorporated by reference herein.

### FIELD OF TECHNOLOGY

The present technology relates to battery packs for electric vehicles.

### BACKGROUND

Motorcycles, all-terrain vehicles, side-by-side vehicles, and snowmobiles are popular transport and recreational vehicles. As the move toward electrification of vehicles progresses, interest in battery packs for various recreational vehicles increases.

Different vehicles have different power requirements, such as the total current output or total voltage across the battery assembly. In many recreational and transport vehicles, space available for different electronic components such as a battery pack, charging components, and components for managing power distribution can be strictly limited.

Cooling of different battery and electronic components is further a challenge to be addressed for electric powerpacks in different electric vehicles. Space limitations affecting the component arrangements similarly limits space available for cooling system components. Further, tight packing of heat-generating components can in some cases compound cooling requirements. When addressing different types of vehicles with different space constraints and different power requirements, it is further noted that the number of designs could quickly multiply.

There therefore remains a desire for battery arrangements for electric vehicles addressing at least some of the above described disadvantages.

### SUMMARY

It is an object of the present technology to ameliorate at least some of the inconveniences present in the prior art.

According to aspects of the present technology, there is provided a powerpack for an electric vehicle in which battery pack components are arranged in a generally compact manner while providing an arrangement for managing temperatures within the interior of the battery pack. The battery housing also includes a heat transfer channel defined through a center thereof. The heat transfer channel is fluidly connected to a heat transfer system of the vehicle, permitting the battery cells to be cooled during operation while maintaining an efficient spatial arrangement of the battery pack. Layers of heat conducting materials are included in the battery pack, between the battery cells and the heat transfer channel, to promote heat transfer therebetween. A heat conducting adhesive material, one or more heat transferring plates, and an additional layer of heat conducting adhesive material are disposed between the battery cells and the heat transfer channel. A layer of dielectric material is also included between the battery cells and the heat transfer plate to reduce electrical conduction therebetween, which could lead to shorting connections between different battery cells. The heat transfer fluid in the channel can thus, when in operation, absorb heat efficient from the battery cells via the heat conducting layers. In some cases, for example when operating in cold conditions, the heat transfer channel may also be used to heat the battery cells up to a minimum operating temperature.

According to an aspect of the present technology, there is provided a battery pack for an electric vehicle, the battery pack including a battery housing including: a housing body, at least one heat transfer channel defined in the housing body, the at least one heat transfer channel being operative to convey a heat transfer fluid therethrough; a plurality of battery cells disposed in the housing body; at least one heat transfer plate disposed between the plurality of battery cells and the at least one heat transfer channel; at least one layer of thermally conductive adhesive material disposed between the plurality of battery cells and the at least one heat transfer plate; and at least one layer of dielectric material disposed between the plurality of battery cells and the at least one heat transfer plate, the at least one dielectric layer being configured to electrically insulate the at least one heat transfer plate from the plurality of battery cells, the plurality of battery cells being disposed in thermal communication with the at least one heat transfer channel via the thermally conductive adhesive material and the at least one heat transfer plate.

In some embodiments, the at least one layer of thermally conductive adhesive material at least partially surrounds a cell end portion of at least some of the battery cells of the plurality of battery cells.

In some embodiments, the at least one layer of thermally conductive adhesive material has dielectric properties.

In some embodiments, the at least one dielectric layer includes a layer of plastic-based material applied to a surface of the at least one heat transfer plate.

In some embodiments, the plurality of battery cells is grouped in a plurality of battery modules; each battery module of the plurality of battery modules includes a portion of the plurality of battery cells; the at least one heat transfer plate includes a plurality of heat transfer plates; each heat transfer plate of the plurality of heat transfer plates is in thermal communication with a corresponding battery module of the plurality of battery modules; and the at least one layer thermally conductive adhesive material includes a plurality of layers of thermally conductive adhesive material; each layer of the plurality of layers of thermally conductive adhesive material is disposed in a corresponding battery module of the plurality of battery modules between a corresponding heat transfer plate and battery cells thereof.

In some embodiments, each battery module of the plurality of battery modules includes a rigid support matrix for receiving the portion of the plurality of battery cells therein.

In some embodiments, the at least one layer of thermally conductive adhesive material is arranged to maintain a position of the portion of the plurality of battery cells in the rigid support matrix.

In some embodiments, the at least one layer of thermally conductive adhesive material is at least one first layer of thermally conductive adhesive material; the battery pack further comprises at least one second layer of thermally conductive adhesive material disposed between the plurality of heat transfer plates and the housing body; and the at least one second layer of thermally conductive adhesive material is arranged to maintain a position of each of the plurality of battery modules in the housing.

In some embodiments, the at least one heat transfer channel extends generally through a center portion of the housing body.

In some embodiments, the at least one heat transfer plate includes a plurality of heat transfer plates; and each plate of the plurality of heat transfer plates is sized and positioned to be in thermal communication with a portion of the plurality of battery cells.

In some embodiments, the at least one heat transfer plate is formed from aluminum.

In some embodiments, the at least one heat transfer plate is shaped and sized to conform with a portion of a surface of the housing body.

In some embodiments, the thermally conductive adhesive material includes a thermally conductive resin.

In some embodiments, the at least one layer of thermally conductive adhesive material is at least one first layer of thermally conductive adhesive material; and further including at least one second layer of thermally conductive adhesive material disposed between the at least one heat transfer plate and the housing body.

In some embodiments, the at least one second layer of thermally conductive adhesive material includes: a thermally conductive resin; and a thermal conduction dopant material added to the thermally conductive resin, the thermal conduction dopant material being configured to increase thermal conductivity of the thermally conductive resin.

In some embodiments, the thermal conduction dopant material is a metallic dopant material.

In some embodiments, the at least one heat transfer channel is arranged to allow, when in operation, at least one of: heat to be transferred to the heat transfer fluid flowing through the at least one heat transfer channel from the plurality of battery cells; and heat to be transferred from the heat transfer fluid flowing through the at least one heat transfer channel to the plurality of battery cells.

In some embodiments, the battery pack further includes a first cover selectively connected to the housing body, and a second cover selectively connected to the housing body; and the plurality of battery cells includes: a first plurality of battery cells disposed in a first chamber defined by the housing laterally between the at least one heat transfer channel and the first cover, and a second plurality of battery cells disposed in a second chamber defined by the housing laterally between the at least one heat transfer channel and the second cover.

In some embodiments, when in use, current is collected from a first end portion of each battery cell of the plurality of battery cells; and the at least one layer of thermally conductive adhesive material is in contact with a second end portion of at least one battery cell of the plurality of battery cells, the second end portion being disposed opposite to the first end portion.

According to another aspect of the present technology, there is provided a battery pack for an electric vehicle, the battery pack including a battery housing including a housing body, at least one heat transfer channel defined in the housing body, the at least one heat transfer channel being operative to convey a heat transfer fluid therethrough; and a plurality of battery modules disposed in the battery housing, each battery module of the plurality of battery modules including a plurality of battery cells, a heat transfer plate disposed between the plurality of battery cells and the at least one heat transfer channel, a layer of thermally conductive adhesive material disposed between the plurality of battery cells and the heat transfer plate, and a layer of dielectric material disposed between the plurality of battery cells and the heat transfer plate, the layer of dielectric material being configured to electrically insulate the heat transfer plate from the plurality of battery cells, the plurality of battery cells being disposed in thermal communication with the at least one heat transfer channel via the thermally conductive adhesive material and the heat transfer plate.

In some embodiments, each battery module of the plurality of battery modules further includes a module board comprising an integrated current collector disposed within the battery module, the integrated current collector electrically coupling the plurality of battery cells together.

In some embodiments, for each battery module: the integrated current collector is connected to a first end portion of each battery cell of the plurality of battery cells; and the at least one layer of thermally conductive adhesive material is disposed adjacent to a second end portion of each battery cell of the plurality of battery cells, the second end portion being oppositely disposed to the first end portion.

In some embodiments, the layer of thermally conductive adhesive material has dielectric properties.

In some embodiments, the thermally conductive adhesive material includes a thermally conductive resin.

In some embodiments, for each module, the layer of thermally conductive adhesive material is a first layer of thermally conductive adhesive material; and the battery pack further includes a second layer of thermally conductive adhesive material disposed between the heat transfer plates of the plurality of battery modules and the housing body.

In some embodiments, a position in the housing of each of the plurality of battery modules is maintained by the second layer of thermally conductive adhesive material.

In some embodiments, the second layer of thermally conductive adhesive material includes: a thermally conductive resin; and a thermal conduction dopant material added to the thermally conductive resin, the thermal conduction dopant material being configured to increase thermal conductivity of the thermally conductive resin.

In some embodiments, the thermal conduction dopant material is a metallic dopant material.

In some embodiments, each battery module of the plurality of battery modules further includes a rigid support matrix for receiving the plurality of battery cells therein.

In some embodiments, for each module, the layer of thermally conductive adhesive material is arranged to maintain a position of the plurality of battery cells in the rigid support matrix.

In some embodiments, the heat transfer plate is formed from aluminum.

In some embodiments, the heat transfer plate is shaped and sized to conform with a portion of a surface of the housing body.

In some embodiments, for each module, the layer of dielectric material includes a layer of plastic-based material applied to a surface of the heat transfer plate.

In some embodiments, the at least one heat transfer channel is arranged to allow, when in operation, at least one of: heat to be transferred to the heat transfer fluid flowing through the at least one heat transfer channel from the plurality of battery cells; and heat to be transferred from the heat transfer fluid flowing through the at least one heat transfer channel to the plurality of battery cells.

For the purposes of the present application, terms related to spatial orientation such as forward, rearward, front, rear, upper, lower, left, and right, are as they would normally be understood by a driver of a vehicle sitting therein in a normal driving position with the vehicle being upright and steered in a straight ahead direction. Specifically, the terms relating to spatial orientation should be understood as they would be understood when the presently described components are mounted to a vehicle, according to at least some embodiments.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, left side perspective view of a battery pack according to non-limiting embodiments of the present technology;

FIG. 2 is a top, rear, right side perspective view of the battery pack of FIG. 1;

FIG. 3 is a left side elevation view of the battery pack of FIG. 1;

FIG. 4 is a perspective, partially-exploded view of portions of a powerpack including the battery pack of FIG. 1;

FIG. 5 is a top, rear, right perspective, partially-exploded view of the battery pack of FIG. 1;

FIG. 6 is a top, rear, right side perspective view of housing covers and a housing body of the battery pack of FIG. 1;

FIG. 7 is a top, rear, left side perspective view of the battery pack of FIG. 1, with housing covers having been removed;

FIG. 8 is a left side elevation view of the battery pack with housing covers having been removed of FIG. 6;

FIG. 9 is a right side elevation view of the battery pack with housing covers having been removed of FIG. 6;

FIG. 10 is a partial, cross-sectional view of portions of the battery pack of FIG. 1, taken along line 10-10 of FIG. 3;

FIG. 11 is a top, rear, left side perspective view of a battery module of the battery pack of FIG. 1, shown in isolation;

FIG. 12 is a close-up, partial view of the battery module of FIG. 11;

FIG. 13 is a front, right side perspective view of the battery pack of FIG. 1, with one battery module shown in an exploded view;

FIG. 14 is a cross-sectional view of the battery module of FIG. 11; and

FIG. 15 is a close-up view of a portion of the battery pack cross-section of FIG. 10, taken from the box 15 of FIG. 10.

It should be noted that, unless otherwise explicitly specified herein, the drawings are not necessarily to scale.

### DETAILED DESCRIPTION

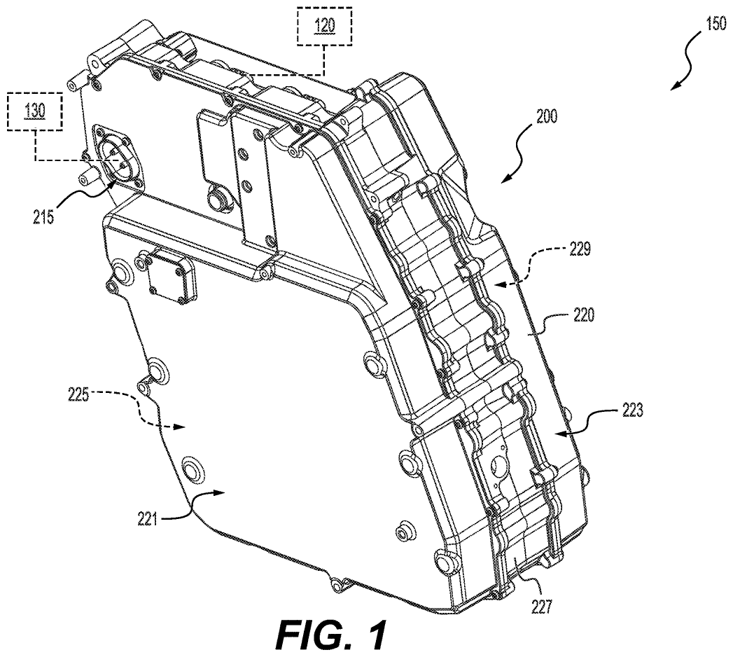

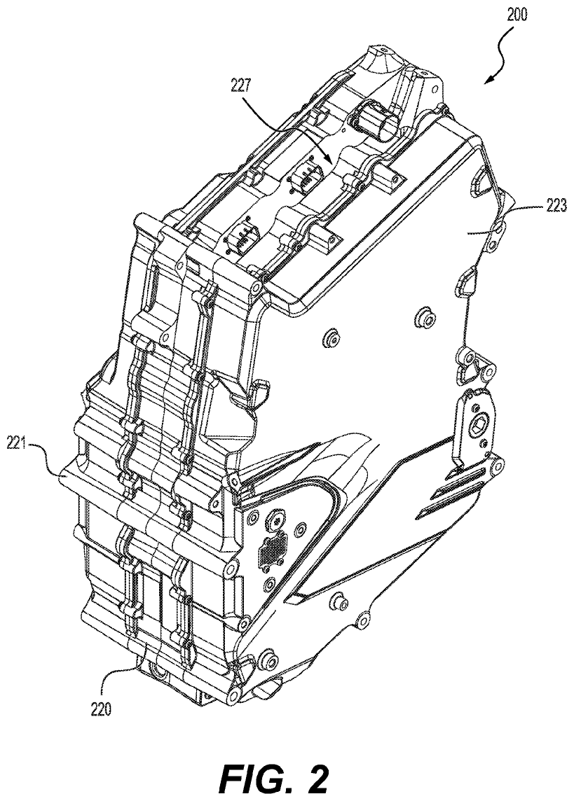

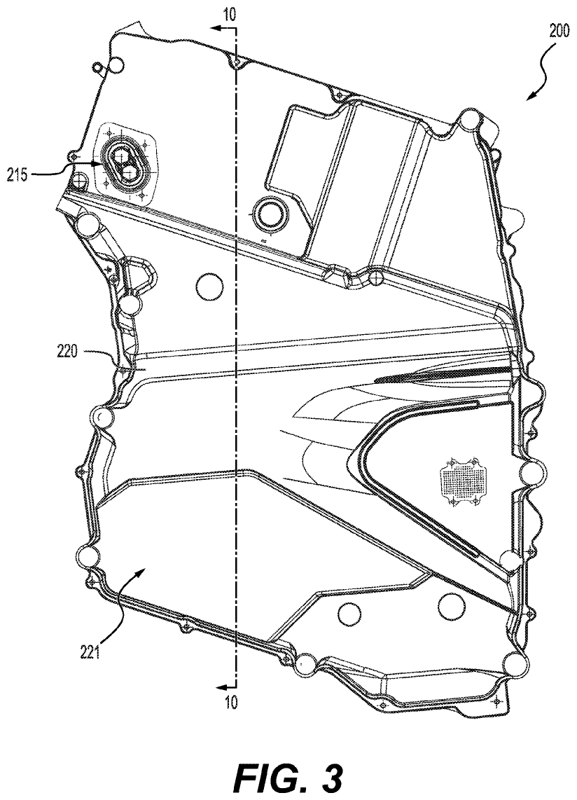

The present technology will be described herein with respect to a battery pack 200, illustrated in FIGS. 1 to 6, for powering an electric vehicle (not shown). The battery pack 200 could be implemented in a variety of vehicle types, including but not limited to two-wheeled straddle-seat electric vehicles (e.g., electric motorcycles, electric scooters), three-wheeled straddle-seat electric vehicles, electric snowmobiles, electric all-terrain vehicles (ATVs), electric side-by-side vehicles (SSVs), and four-wheeled electric vehicles.

The battery pack 200 includes a battery housing 220. The battery housing 220 encloses different components of the battery pack 200 and provides connections for connecting to other vehicle components (described further below). In the illustrated embodiment of the battery pack 200, the battery housing 220 (and the corresponding layout of components disposed therein) is shaped for use in a straddle-seat vehicle. In different embodiments of the present technology, it is contemplated that the battery housing 220 could be differently shaped. In some non-limiting examples, the battery housing 220 could be shaped for use in a vehicle having side-by-side seating or in four-wheeled electric vehicles having a passenger cabin.

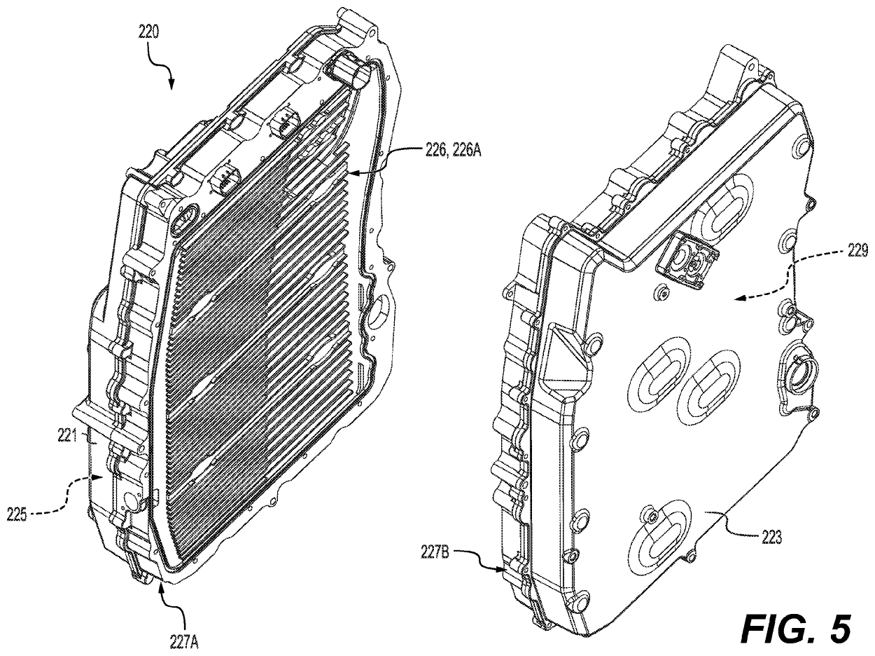

The battery housing 220 includes a housing body 227, forming a center portion of the housing 220. As is illustrated in at least FIG. 5, the housing body 227 includes a left lateral portion 227A and a right lateral portion 227B connected together to form the body 227. In the illustrated embodiment the left and right lateral portions 227A, 227B are selectively connected together via threaded fasteners (not shown). It is contemplated that the left and right lateral portions 227A, 227B could be otherwise connected together in different manners. In the present embodiment, the housing body 227 is formed from aluminum, but could be formed from different materials, including but not limited to plastic or other metals.

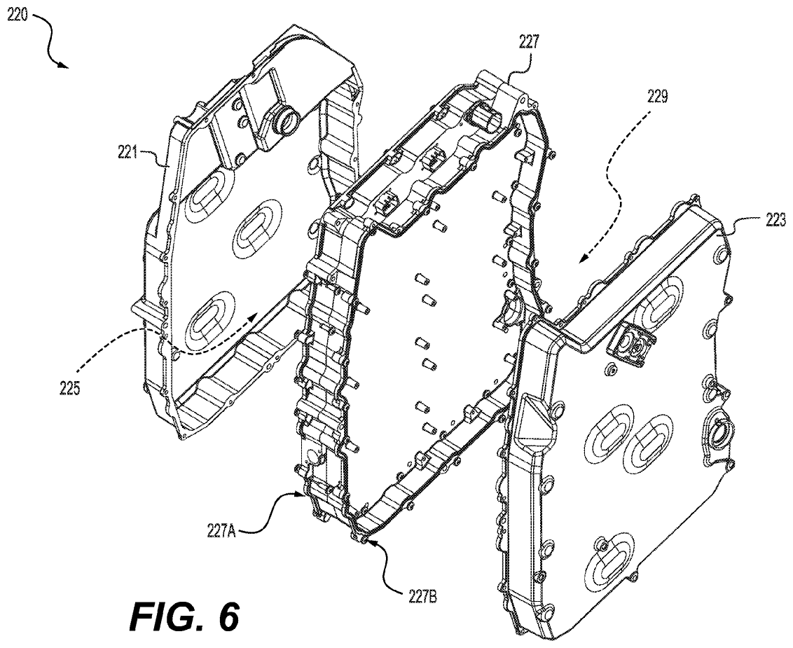

The battery housing 220 includes a left side cover 221 selectively connected to the housing body 227, specifically selectively connected to the left lateral portion 227A. The housing 220 similarly includes a right side cover 223 selectively connected to the housing body 227, specifically selectively connected to the right lateral portion 227B. Each cover 221, 223 is selectively fastened to the housing body 227 to encase the components therein. It is contemplated that the covers 221, 223 could be selectively connected to the housing body 227 in different manners, including for example by tabs. A left chamber 225 is formed between the center portion of the housing body 227 and the left cover 221. A right chamber 229 is formed between the center portion of the housing body 227 and the right cover 223. The left and right chambers 225, 229 are shown in the exploded view of FIG. 6.

The battery housing 220 defines a battery heat transfer channel 226 therein, specifically through a center portion of the housing body 227. In some embodiments, it is contemplated that more than one heat transfer channel could be defined through the housing body 227. In the illustrated embodiment, the heat transfer channel 226 extends generally vertically when the battery pack 200 is installed in the electric vehicle. As can be seen in FIG. 5, the battery heat transfer channel 226 includes a plurality of fins extending inward from the housing 220. The battery heat transfer channel 226 is fluidly connected to a heat transfer system (not shown) of the vehicle. Depending on the temperature of operation, the heat transfer system can be used to cool or heat components of the battery pack 200, described in more detail below.

When the battery pack 200 is in operation in the vehicle, heat transfer fluid flows through the channel 226 along a longitudinal direction through the center of the housing body 227. In the illustrated embodiment, the heat transfer fluid is specifically a heat transfer liquid, such as ethylene glycol. In the present embodiment, the heat transfer channel 226 extends generally parallel to the covers 221, 223. An inner face of the left lateral portion 227A includes a first channel form 226A formed thereon and an inner face of the right lateral portion 227B includes a second channel form (not shown) formed thereon. The heat transfer channel 226 is then defined by the space created between the left and right lateral portions 227A, 227B.

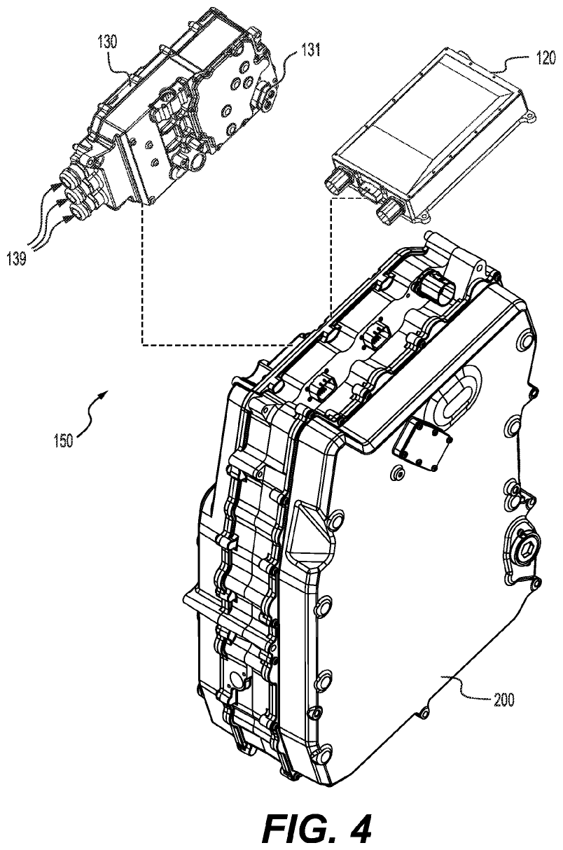

As is partially illustrated in FIG. 4, the battery pack 200 is part of an electric powerpack 150 for powering the electric vehicle. In addition to the battery pack 200, the powerpack 150 includes a charger 120 connected to the battery pack 200. The charger 120 is mounted to the battery housing 220. Specifically, the charger 120 is fastened to the battery housing 220 and is disposed on a top side of the battery housing 220. It is contemplated that the location of the charger 120 relative to the battery pack 200 could vary.

The charger 120 is electrically connected to battery cells 230 of the battery pack 200 for supplying charge thereto; the battery cells 230 and the connection arrangement are described in more detail below. The charger 120 is configured to electrically connect to a socket (not shown) of the vehicle in which the battery pack 200 is installed for electrically connecting to an external power source for providing electricity to the charger 120 for charging the battery pack 200.

The powerpack 150 also includes an inverter 130 disposed on a left side of the battery pack 200. The inverter 130 is fastened to the battery housing 220, specifically along a left side of the battery housing 220. In some embodiments, it is contemplated that the inverter 130 could be disposed on a different location on the battery pack 200.

The inverter 130 includes an electric connector 131 disposed on an exterior of the inverter 130. The battery pack 200 includes an electric connector 215 electrically connected to the battery cells 230 (described in more detail below). The electric connector 215 is disposed on an exterior of the battery housing 220, specifically on a left side of the housing 220. When the vehicle is in operation, the inverter 130 receives electric power from the battery cells 230 via the electric connector 215 and the electric connector 131.

The connector 215 is arranged to receive the connector 131 of the inverter 130, such that the electric connector 215 and the electric connector 131 are selectively connected together for managing electricity flow from the battery pack 200 to other electronic components of the vehicle via the inverter 130. In at least some embodiments, the inverter 130 is configured to electrically connect to a three-phase motor (not shown) via cables connected to three outlets 139 of the inverter 130. It is contemplated that the number of cables, type of electrical connection, and type of motor operatively connected to the inverter 130 could vary in different embodiments. While the inverter 130 connects directly to the battery pack 200 in the present embodiment, it is contemplated that the inverter 130 could be separated and spaced from the battery pack 200 and electrically connected to the battery cells 230 via cables or the like.

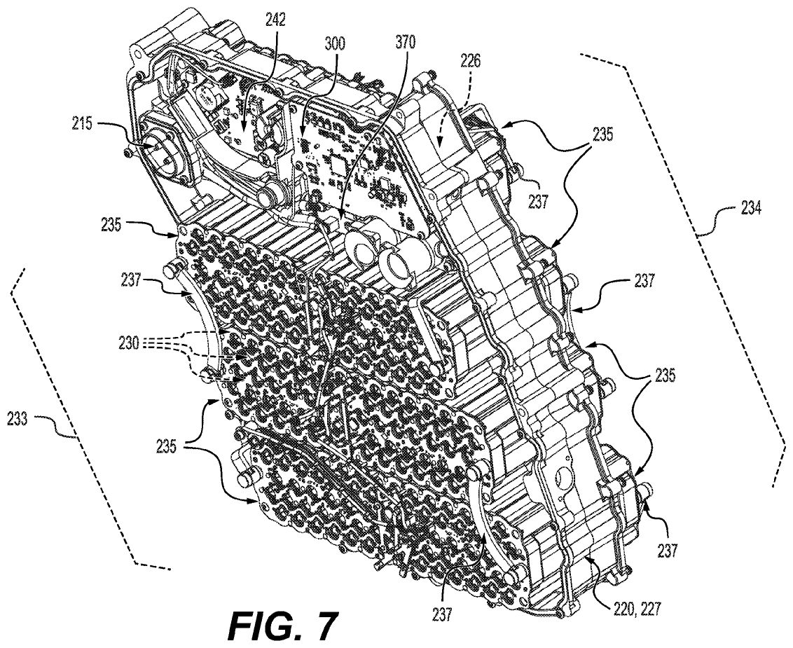

With reference to FIGS. 7 to 9, components of the battery pack 200 disposed inside the housing 220 are illustrated in more detail. As is mentioned briefly above, the battery pack 200 includes a plurality of battery cells 230 disposed in the housing 220. The battery pack 200 also includes a plurality of electronic components disposed in the battery housing 220. The electronic components include at least a DC-DC converter 242, a general battery management system (general BMS) 300, and a battery disconnect unit board (BDU board) 370, disposed in the left chamber 225 of the battery pack 200.

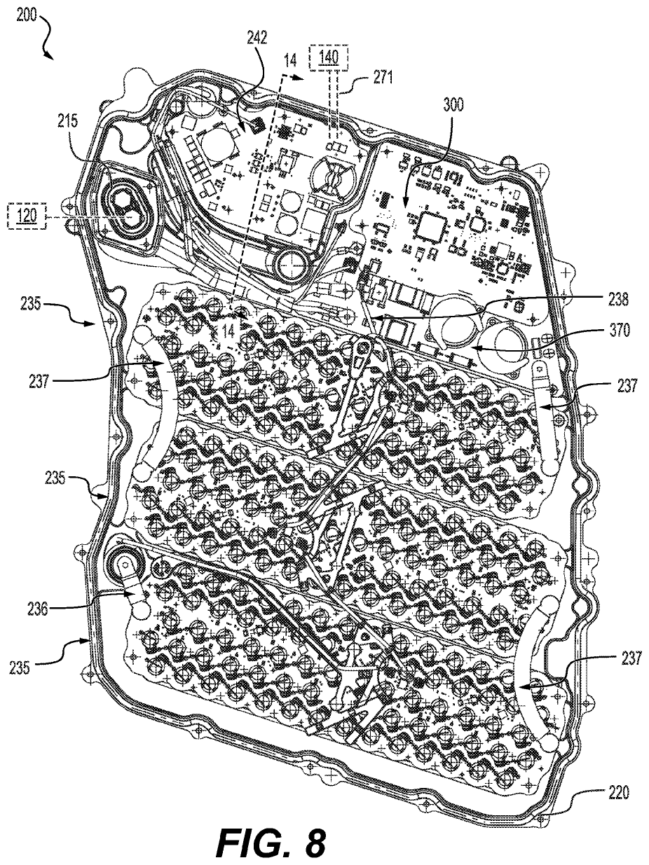

The DC-DC converter 242 is operatively connected to a twelve volt battery 140 (shown schematically in FIG. 8). The DC-DC converter 242 is formed from a printed circuit board (PCB) upon which the electric components are disposed. The DC-DC converter 242 is electrically connected to the battery cells 230 in order to receive electricity therefrom. The DC-DC converter 242 is communicatively and operatively connected to the general BMS 350. The DC-DC converter 242 is arranged to provide power from the battery cells 230 to a low voltage circuit 141 (shown schematically) in order to power different electrical components of the vehicle (other than the inverter 130) that operate at a lower voltage. In the present embodiments, the low voltage circuit 141 provides power to charge the twelve volt battery 140, the BDU board 370, and the general BMS 300. Additionally, the low voltage circuit 141 could further provide power to front and rear lights, navigation systems, on-board control units, dashboard displays, and sound systems.

The general battery management system (general BMS) 300 manages operation of the battery pack 200 and the battery modules 235 in conjunction with module BMS 350 of each battery module 235. The general BMS 300, also referred to as a global BMS 300, is configured for performing a variety of general management tasks for operating the battery pack 200. The general BMS 300 is formed in part by a printed circuit board (PCB), upon which electronic and electrical components of the general BMS 300 are disposed and connected. Depending on the embodiment, it is contemplated that components of the general BMS 300 could be secured to two or more PCBs.

The battery disconnect unit board (BDU board) 370 is generally disposed between the general BMS 300 and center portions of the housing body 227. The BDU board 370 is generally arranged parallel to the general BMS 300. The BDU board 370 is operatively and communicatively connected to the general BMS 300. It is contemplated that all or some of the components of the BDU board 370 could be incorporated into the general BMS 300 and/or that the BDU board 370 and the general BMS 300 could be integrally connected. The general BMS 300 is configured to manage operation of various components of the BDU board 370.

The BDU board 370 is connected to the electric connector 215 and is connected in series to bus bars 237 (described below) electrically connected to the battery cells 230. Power drawn from the battery cells 230 is gathered by the bus bars 237 (described further below), and then provided to the inverter 130 via the electric connector 215 via the BDU board 370. By passing the high voltage battery circuit through the BDU board 370, the BDU board 370 is arranged to interrupt the high voltage current flow when directed by the general BMS 300 or in response to signals from the BDU board controller 372.

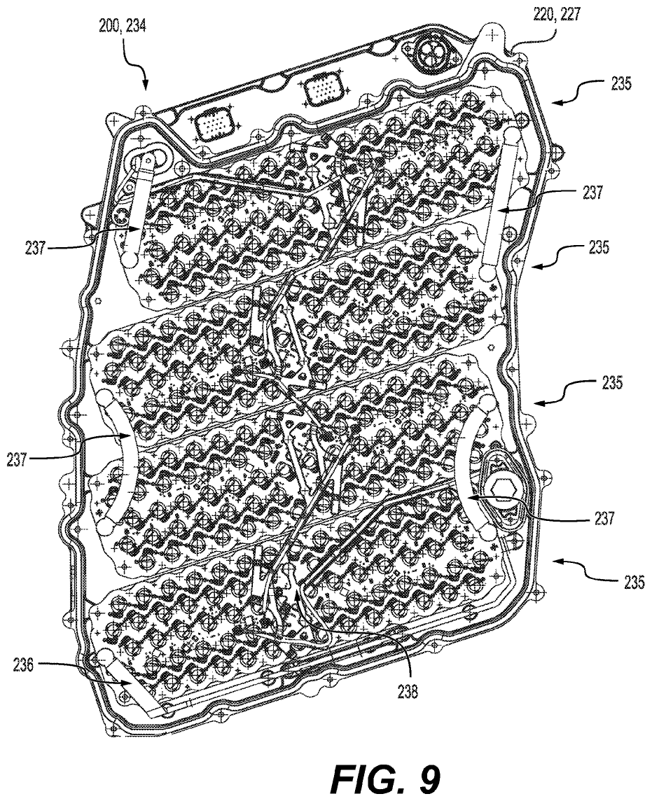

With continued reference to FIGS. 7 and 8, and with additional reference to FIGS. 9 to 12, arrangement of the battery cells 230 of the battery pack 200 is described in more detail. The battery cells 230, in the illustrated embodiment, are arranged in a plurality of battery modules 235 disposed in the battery housing 220. In the present case, the battery pack 200 includes seven modules 235. It is contemplated that different embodiments of the battery pack 200 could include, and the battery cells 230 could be arranged in, more or fewer battery modules 235. In other non-limiting embodiments, it is contemplated that the battery cells 230 could be arranged differently than being grouped into modules.

In the illustrated embodiment, the battery modules 235 are separated into two banks of modules: a left bank 233 having three modules 235 disposed in the left chamber 225 of the housing 220, and a right bank 234 having four modules 235 disposed in the right chamber 229. As such, the left chamber 225, where the DC-DC converter 242, the general BMS 300, and the BDU board 370 are also disposed, has fewer battery cells 230 than the right chamber 229. Depending on the embodiment, the left and right banks 233, 234 of modules 235 could include more or fewer modules 235. It is also contemplated that the left and right banks 233, 234 could have equal numbers of modules 235. The left bank 233 has fewer modules 235 than the right bank 234 in the present embodiment, but it is contemplated that the right bank 234 could have fewer modules 235 than the left bank 233 (the DC-DC converter 242, the general BMS 300, and the BDU board 370 being disposed in the right chamber 229 for instance).

Each battery module 235 includes a portion of the battery cells 230 of the battery pack 200. In the illustrated embodiment, each module 235 includes seventy battery cells 230. The battery pack 200 thus has a total of 490 (four hundred ninety) battery cells 230. It is contemplated that each battery module 235 could include more or fewer battery cells 230. Depending on the number of battery cells 230 in each module 235 and/or the total number of modules 235 in a given embodiment, it is also contemplated that the total number of battery cells 230 in the battery pack 200 could vary.

The battery cells 230 are cylindrical battery cells 230. In the present embodiment, the battery cells 230 are 3.5V cylindrical cells, such as LG™ M50L lithium-ion cells in 21700 format, but it is contemplated that different versions of cells could be used in some embodiments. For example, battery cells could vary in nominal energy capacity, usable energy capacity, discharge rate, cell chemistry and cell type.

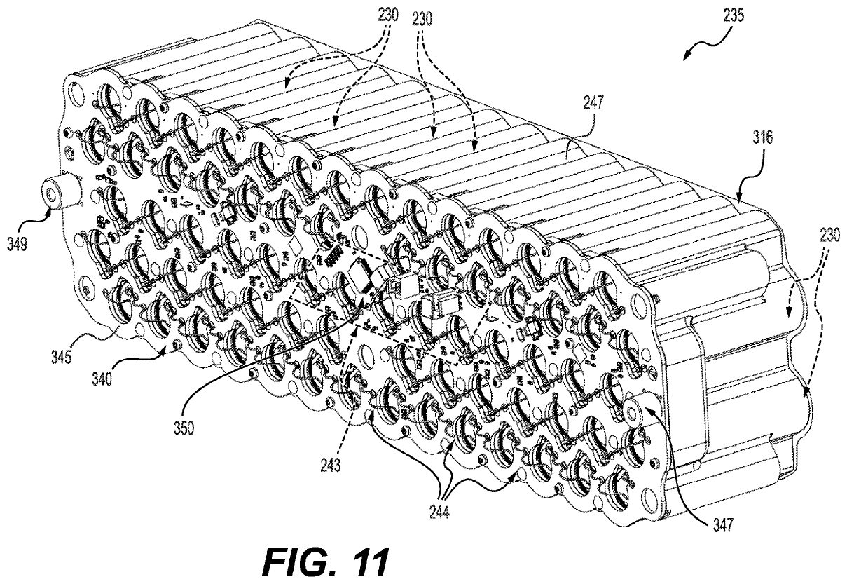

Each module 235 includes a module board 340 electrically connected to the battery cells 230 thereof. The module board 340 includes a module battery management system (module BMS) 350 for managing operation of the battery module 235 (FIG. 11). The module board 340 also includes an integrated current collector 345. The current collector 345 is configured to collect current from the battery cells 230 of the corresponding module 235 when the battery pack 200 is powering the vehicle and inversely for distributing electrical power to each battery cell 230 in the corresponding battery module 235 when the battery pack 200 is charging.

The integrated current collector 345 electrically couples the battery cells 230 together. Specifically, the current collector 345 connects to an outer end portion 231 of each battery cell 230, the outer end portion 231 referring to the end of each battery cell 230 disposed nearer the covers 221, 223 and the end opposite the center housing body 227 (see FIG. 7). In the present embodiment, the module board 340 thus serves to both collect current from the battery cells 230 and to monitor operating conditions of the battery cells 230 via the module BMS 350 in conjunction with the general BMS 300. Broadly, the general BMS 300 is communicatively connected to the module BMS 350 of each battery module 235.

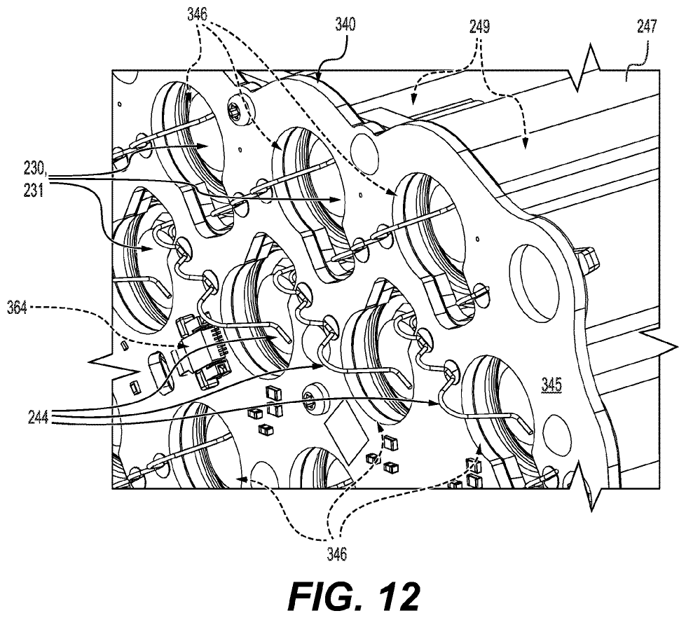

As is illustrated in more detail in FIG. 12, the battery cells 230 are connected to the PCB 245 via wire bonding. The integrated current collector/PCB 345 of the module board 340 defines a plurality of apertures 346 therein to allow electrical connection of the end portions 231 of the battery cells 230 to the module board 340/PCB 345. The module board 340 includes a plurality of wire bonds 244 for connecting the battery cells 230 to the PCB 345, and in turn connecting the battery cells 230 together. Each wire bond 244 connects an outer perimeter of the end portion 231 of one battery cell 230 (the negative terminal) to an inner part of the end portion 231 of a neighboring battery cell 230 (the positive terminal). The apertures 346 in the PCB 345 are shaped to allow connection to the negative terminal of each battery cell 230 at a specific location, and otherwise covers remaining portions of the negative terminal. The apertures 346 in the PCB 345 generally leave the positive terminals of each battery cell 230 exposed, but it is contemplated that portions of the positive terminal could be partially covered by the PCB 345 as well.

Each bank 233, 234 of battery modules 235 is electrically connected together in series by a plurality of bus bars 237 to collect current from each module 235. The three PCBs 345 of the left bank 233 are electrically connected to one another in series via the bus bars 237 and the four PCBs 345 of the right bank 234 are electrically connected to one another in series via the bus bars 237. The two banks 233, 234 are connected together through a connecting bus bar 236 extending through the housing 220. The specific placement and forms of the bus bars 236, 237 could vary, depending on the particular embodiment.

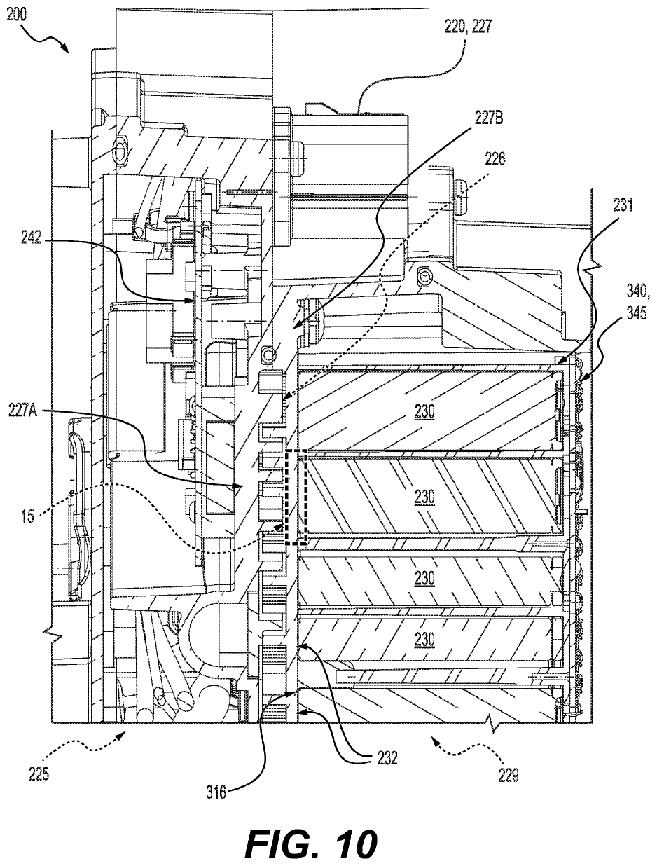

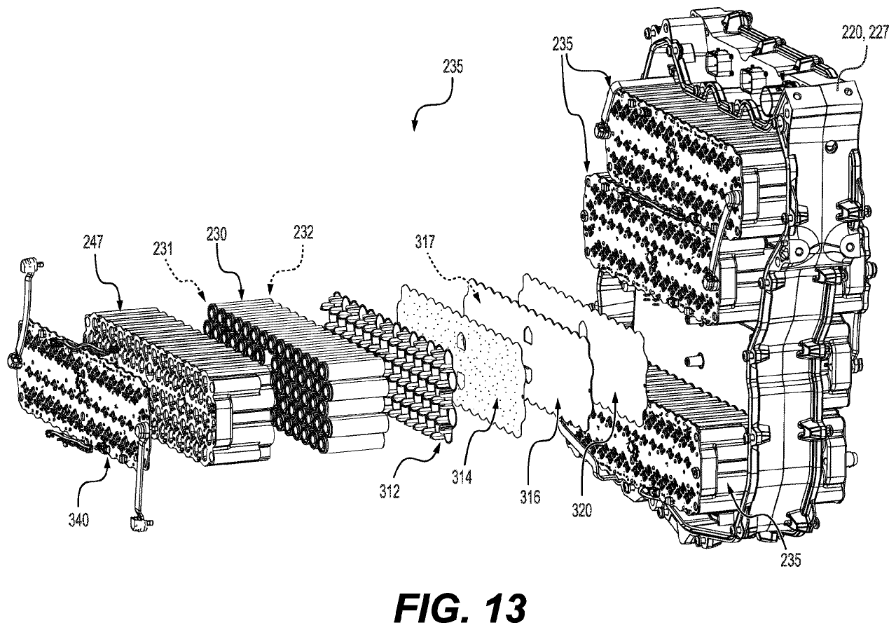

With continued reference to FIGS. 10 to 12, and additional reference to FIG. 13, each module 235 includes a rigid support matrix 247 for supporting the battery cells 230. The support matrix 247 is formed from a rigid, electrically isolating material, specifically a rigid plastic in the present embodiment. The matrix 247 defines therein seventy generally cylindrical cavities 249 for receiving the battery cells 230 in the support matrix 247. In the illustrated embodiment, the support matrix 247 is formed such that the seventy battery cells 230 of each module 235 are arranged in five parallel rows of fourteen cells 230. It is contemplated that the particular physical distribution in each module 235 could vary. In embodiments where different size formats of cylindrical cells are used, it is contemplated that the matrix 247 could be sized and shaped to receive the different battery format therein.

Outer ends 231 of the battery cells 230 are restrained by an outer end of the rigid matrix 247, although it is contemplated that other structures could be utilized to maintain the battery cells 230 in the support matrix 247 in different embodiments. Inner ends 232 of the battery cells 230 are maintained in the rigid matrix 247 by a plurality of thermal conduction layers, described further below. It is contemplated that additional components could be included to aid in maintaining the cells 230 in the matrix 247.

The battery modules 235 are arranged such that a long axis of each cylindrical battery cell 230 extends generally orthogonally to the center portion of the housing body 227 and the lateral outer surfaces of the left and right side covers 221, 223. As is mentioned above, the outer end portions 231 of the battery cells 230 are disposed nearer the left and right side covers 221, 223. Inner ends 232 of the cells 230 are disposed closer to the housing body 227, opposite the electrical connections with the current collector 345.

As is noted above, the battery modules 235 disposed in the left chamber 225 and the right chamber 229 of the housing 220, between the housing body 227 and the covers 221, 223. The inner side of each battery module 235 is in thermal communication with the housing body 227 to allow for heat conduction between the modules 235, and more specifically the battery cells 230, and the heat transfer channel 226.

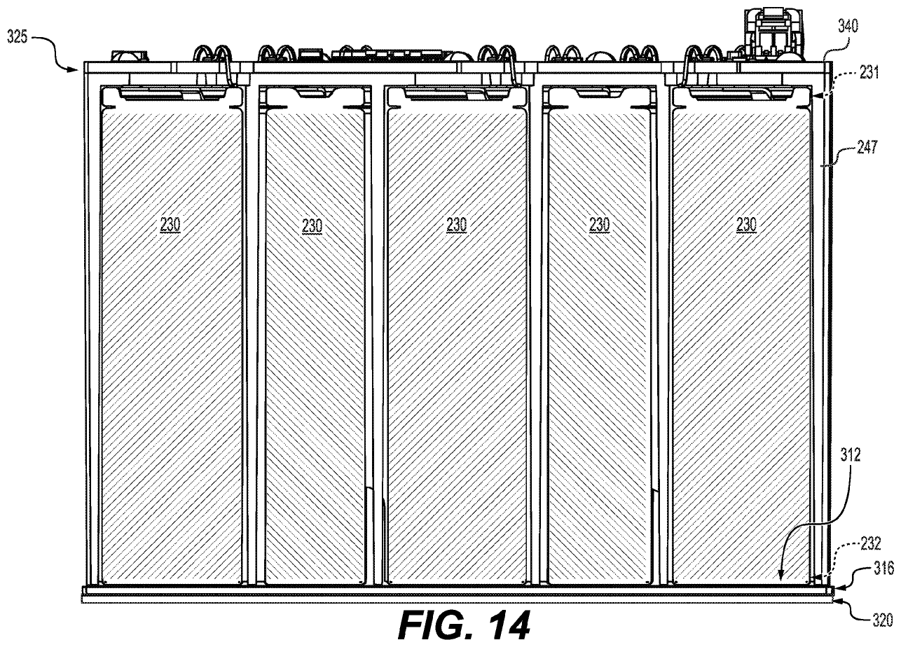

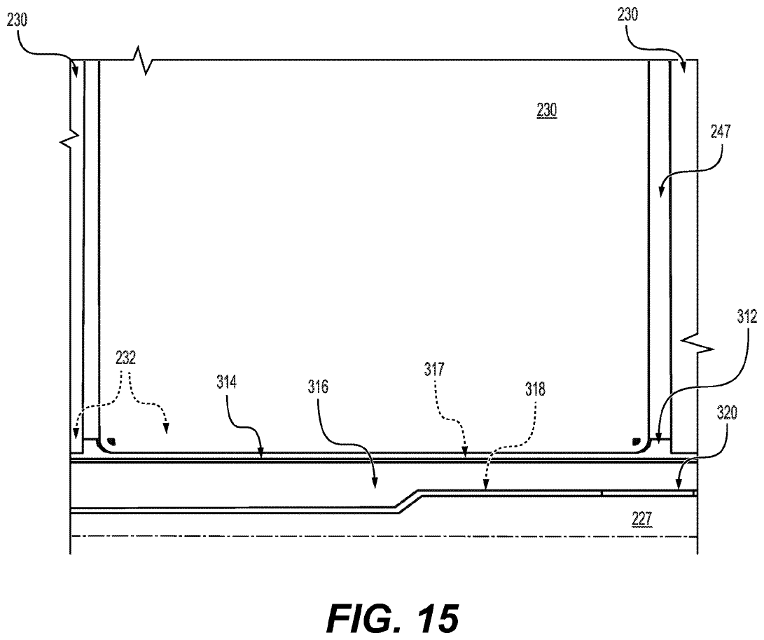

With continued reference to FIGS. 10 and 13, and additional reference to FIGS. 14 and 15, each battery module 235 includes a plurality of thermal conduction layers for promoting heat transfer between the battery cells 230 and the housing body 227 (and the heat transfer fluid in the heat transfer channel 226 during operation). In at least some embodiments, the conduction layers also aid in attaching the modules 235 to the housing body 227 and/or maintaining the position of the modules 235 relative to the housing body 227. In the present embodiment, the battery modules 235 are identical and only one module 235 will be described in detail below. It is contemplated that in some embodiments, there could be variation between battery modules 235.

The battery module 235 includes a layer 312 of thermally conductive adhesive material adhered to the inner ends of the battery cells 230. While referred to as one layer herein for simplicity, it is noted that the layer 312 could be one continuous layer of material or series of material layers applied consecutively in order to form the “layer” 312.

In the present embodiment, the thermally conductive adhesive material includes a thermally conductive resin for forming a rigid and thermally conducting contact with the battery cells 230. The thermally conductive adhesive material could be thermally conductive urethane containing glass beads. In at least some embodiments, the adhesive material of layer 312 could have dielectric properties to aid in electrically insulating the battery cells 230 (specifically the inner ends 232 thereof) from the housing body 227 and remaining layers (described below) between the battery module 235 and housing body 227.

The layer 312 of thermally conductive adhesive material is arranged to maintain the position the battery cells 230 in the rigid support matrix 247. As is illustrated in FIG. 13, the layer 312 partially surrounds the cell end portions 232 of the battery cells 230. The additional contact between the layer 312 and the battery cells 230, beyond simply contacting the flat end faces of the cell ends 232, aids in increasing the thermal conduction between the layer 312 and the battery cells 230, as well securing the layer 312 to the rigid matrix 247.

When the battery pack 200 is in use, current is collected from the first end portion 231 of each battery cell 230, as is noted above, with both the positive and negative terminals being arranged at the first end 231 of the battery cells 230. This arrangement permits the layer 312 of thermally conductive adhesive material to be in contact with the second end portion 232 of some or all of the battery cells 230 for heat transfer while not interfering with the current collection arrangement.

The battery module 235 also includes a heat transfer plate 316 disposed between the battery cells 230 and the heat transfer channel 226. Specifically, the thermally conductive layer 312 is disposed between the battery cells 230 and the heat transfer plate 316. The battery cells 230 are thus disposed in thermal communication with the heat transfer channel 226 via the layer 312 of thermally conductive adhesive material and the heat transfer plate 316.

While one heat transfer plate 316 is sized and shaped to conduct heat to and from the battery cells 230 of one module 235 in the present embodiment, different heat transfer plate arrangements are contemplated. Different possible arrangements include, but are not limited to, one heat transfer plate extending along an inner side of each bank 233, 234 of modules 235 and multiple heat transfer plates per module 235 extending along the inner side of each bank 233, 234 of modules 235 without being specifically arranged to align with a corresponding module 235 (i.e., not in a 1:1 arrangement).

In the present embodiment, the layer 312 generally adheres the heat transfer plate 316 to the battery cells 230 and the rigid matrix 247. In at least some embodiments, it is contemplated that the heat transfer plate 316 could be connected to the rigid matrix 247 through other means, such as by fasteners.

In the illustrated embodiment, the heat transfer plate 316 is formed from aluminum, which can be machined or otherwise formed to the desired shape. Other thermally conducting materials are contemplated, including but not limited to, other metals. The heat transfer plate 316 is configured and arranged to aid in promoting heat transfer between the layer 312 and the housing body 227 (and the heat transfer fluid in the heat transfer channel 226 therein). Specifically, the heat transfer plate 316 is shaped and sized to conform with at least a portion of a surface of the housing body 227. As is exemplified in FIG. 15, an outer surface 317 of the plate 316 is generally flat and arranged parallel to the cell end portions 232 of the battery cells 230. An inner surface 318 of the plate 316, in contrast, is shaped to conform with the housing body 227. By adapting the shape of the inner surface 318 of the plate 316 based on the housing body 227, while the outer surface 317 is parallel and equidistant from the battery cells, variation of thermal conduction between the battery cells 230 and the channel 226 due to irregular spacing therebetween can be decreased. It is noted that the scale of irregularities in the flatness of the housing body 227 is not meant to be particularly limited by the present description; in some cases, a generally flat surface with surface finish irregularities may be addressed by the present technology.

The battery module 235 further includes a layer 314 of dielectric material disposed between the battery cells 230 and the heat transfer plate 316. The dielectric layer 314 is configured to electrically insulate the heat transfer plate 316 from the battery cells 230. While the heat transfer plate 316 aids in improving thermal conduction from the battery cells 230 to the heat transfer channel 226, presence of a conducting plate (generally electrically conducting as well as thermally conducting) could provide some electrical connection between battery cells 230 within the module 235. The dielectric layer 314 thus electrically insulates the heat transfer plate 316 from the battery cells 230 to decrease the possibility of the inter-battery electrical conduction and to decrease the possibility of the electrical conduction between the battery cells 230 and the battery housing 227.

In the present embodiment, the dielectric layer 314 is applied directly to the outer surface 317 of the heat transfer plate 316. The heat transfer plate 316 is thus adhered to the adhesive layer 312 via the dielectric layer 314. For example, the dielectric layer 314 could include a layer of plastic-based material applied to the outer surface 317. Different materials could be selected for the dielectric layer 314, including but not limited to: epoxy and ceramic. In some embodiments, the dielectric layer 314 could be sandwiched between the plate 316 and the layer 312, for example using a rigid or flexible dielectric sheet.

The battery module 235 further includes an additional inner layer 320 of thermally conductive adhesive material disposed between the heat transfer plate 316 and the housing body 227. Similarly to the layer 312, it is noted that the layer 320 could be one continuous layer of material or series of material layers applied consecutively in order to form the “layer” 320.

The layer 320 provides thermal communication between the heat transfer plate 316 and the housing body 227. While illustrated as being included with each module 235 in the present embodiment, it is contemplated that the layer 320 could extend continuously along the surface of the housing body 227. In such an arrangement, the heat transfer plate 316 of each module 235 of each bank 233, 234 contacts the same thermally conductive layer 320. By using thermally conductive adhesive material, the layer 320 further aids in maintaining the battery module 235 in its corresponding chamber 225, 229. In at least some embodiments, the layer 320 of thermally conductive adhesive material is also arranged to maintain a position of the battery module 235 within the housing 220. In the illustrated embodiment, the battery modules 235 are fastened to the housing body 227 using bolts (not shown). In some embodiments, the layer 320 of adhesive could be used to secure the modules 235 to the housing body 227 or could be used to assist in securing the modules 235 to the housing body 227.

In the illustrated embodiment, the layer 320 is formed from a thermally conductive resin. Specifically, the layer 320 includes a thermal conduction dopant material added to the thermally conductive resin. The thermal conduction dopant material is configured to increase thermal conductivity of the thermally conductive resin. In the present case, the thermal conduction dopant material is a metallic dopant material, although other dopant materials could be chosen. It is noted that in contrast to the layer 312, which must be electrically insulated from the plate 416, the layer 320 can be formed from an electrically conductive material as the layer 320 is not in contact with the battery cells 230 and is separated therefrom by the dielectric layer 314. In at least some other embodiments, it is contemplated that the layers 312 and 320 could be formed from the same type of material (i.e., without doping), for example for simplicity of fabrication.

The heat transfer channel 226, disposed in the housing body 227, center portion of the housing 220, as is described above, is thus in thermal communication with the banks of battery cells 230 disposed on both a right side of the channel 226 and a left side of the channel 226. Inner ends 232 of the battery cells 230 of each bank 233, 234 are in thermal communication with the heat transfer channel 226 through the housing body 227 and through the heat conducting layers 312, 316, 320. When in operation, heat transfer liquid flowing through the battery heat transfer channel 226 generally absorbs heat from inner ends 232 of the battery cells 230 on each lateral side of the battery heat transfer channel 226. When starting the electric vehicle in cold conditions, heat transfer liquid flowing through the battery heat transfer channel 226 may provide heat to the inner ends 232 of the battery cells 230 on each lateral side of the battery heat transfer channel 226.

The heat transfer channel 226 is thus arranged to allow, when in operation, heat to be transferred to the heat transfer liquid flowing through the heat transfer channel 226 from the battery cells 230 and/or heat to be transferred from the heat transfer liquid flowing through the heat transfer channel 226 to the battery cells 230. When the battery pack 200, or components therein, generate heat during operation of the electric vehicle, the heat transfer system is used to remove heat from the electronic components and the battery cells 230 in order to maintain the components of the battery pack 200 within predetermined temperature limits. When operating the electric vehicle in cold conditions, the heat transfer system is used to provide heat to the electronic components and the battery cells 230 in order to bring the components of the battery pack 200 up to a minimum operating temperature, including for example for vehicle start-up.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A battery pack for an electric vehicle, the battery pack comprising:
a battery housing including:
a housing body,
at least one heat transfer channel defined in the housing body, the at least one heat transfer channel being operative to convey a heat transfer fluid therethrough;
a plurality of battery cells disposed in the housing body;
at least one heat transfer plate disposed between the plurality of battery cells and the at least one heat transfer channel;
at least one layer of thermally conductive adhesive material disposed between the plurality of battery cells and the at least one heat transfer plate; and
at least one layer of dielectric material disposed between the plurality of battery cells and the at least one heat transfer plate, the at least one dielectric layer being configured to electrically insulate the at least one heat transfer plate from the plurality of battery cells,
the plurality of battery cells being disposed in thermal communication with the at least one heat transfer channel via the thermally conductive adhesive material and the at least one heat transfer plate.

2. The battery pack of claim 1, wherein the at least one layer of thermally conductive adhesive material at least partially surrounds a cell end portion of at least some of the battery cells of the plurality of battery cells.

3. The battery pack of claim 1, wherein the at least one layer of thermally conductive adhesive material has dielectric properties.

4. (canceled)

5. The battery pack of claim 1, wherein:
the plurality of battery cells is grouped in a plurality of battery modules;
each battery module of the plurality of battery modules includes a portion of the plurality of battery cells;
the at least one heat transfer plate includes a plurality of heat transfer plates;
each heat transfer plate of the plurality of heat transfer plates is in thermal communication with a corresponding battery module of the plurality of battery modules;
the at least one layer thermally conductive adhesive material includes a plurality of layers of thermally conductive adhesive material; and
each layer of the plurality of layers of thermally conductive adhesive material is disposed in a corresponding battery module of the plurality of battery modules between a corresponding heat transfer plate and battery cells thereof.

6. The battery pack of claim 5, wherein:
each battery module of the plurality of battery modules includes a rigid support matrix for receiving the portion of the plurality of battery cells therein; and
the at least one layer of thermally conductive adhesive material is arranged to maintain a position of the portion of the plurality of battery cells in the rigid support matrix.

7. (canceled)

8. The battery pack of claim 7, wherein:
the at least one layer of thermally conductive adhesive material is at least one first layer of thermally conductive adhesive material;
the battery pack further comprises at least one second layer of thermally conductive adhesive material disposed between the plurality of heat transfer plates and the housing body; and
the at least one second layer of thermally conductive adhesive material is arranged to maintain a position of each of the plurality of battery modules in the housing.

9. (canceled)

10. The battery pack of claim 1, wherein:
the at least one heat transfer plate includes a plurality of heat transfer plates; and
each plate of the plurality of heat transfer plates is sized and positioned to be in thermal communication with a portion of the plurality of battery cells.

11.-13. (canceled)

14. The battery pack of claim 1, wherein:
the at least one layer of thermally conductive adhesive material is at least one first layer of thermally conductive adhesive material; and
further comprising:
at least one second layer of thermally conductive adhesive material disposed between the at least one heat transfer plate and the housing body.

15. The battery pack of claim 14, wherein the at least one second layer of thermally conductive adhesive material includes:
a thermally conductive resin; and
a thermal conduction dopant material added to the thermally conductive resin, the thermal conduction dopant material being configured to increase thermal conductivity of the thermally conductive resin.

16. The battery pack of claim 15, wherein the thermal conduction dopant material is a metallic dopant material.

17. (canceled)

18. The battery pack of claim 1, further comprising:
a first cover selectively connected to the housing body, and
a second cover selectively connected to the housing body; and
wherein:
the plurality of battery cells includes:
a first plurality of battery cells disposed in a first chamber defined by the housing laterally between the at least one heat transfer channel and the first cover, and
a second plurality of battery cells disposed in a second chamber defined by the housing laterally between the at least one heat transfer channel and the second cover.

19. The battery pack of claim 1, wherein:
when in use, current is collected from a first end portion of each battery cell of the plurality of battery cells; and
the at least one layer of thermally conductive adhesive material is in contact with a second end portion of at least one battery cell of the plurality of battery cells, the second end portion being disposed opposite to the first end portion.

20. A battery pack for an electric vehicle, the battery pack comprising:
a battery housing including:
a housing body,
at least one heat transfer channel defined in the housing body, the at least one heat transfer channel being operative to convey a heat transfer fluid therethrough; and
a plurality of battery modules disposed in the battery housing, each battery module of the plurality of battery modules comprising:
a plurality of battery cells,
a heat transfer plate disposed between the plurality of battery cells and the at least one heat transfer channel,
a layer of thermally conductive adhesive material disposed between the plurality of battery cells and the heat transfer plate, and
a layer of dielectric material disposed between the plurality of battery cells and the heat transfer plate, the layer of dielectric material being configured to electrically insulate the heat transfer plate from the plurality of battery cells, the plurality of battery cells being disposed in thermal communication with the at least one heat transfer channel via the thermally conductive adhesive material and the heat transfer plate.

21. The battery pack of claim 20, wherein:
each battery module of the plurality of battery modules further comprises:
a module board comprising an integrated current collector disposed within the battery module, the integrated current collector electrically coupling the plurality of battery cells together; and
for each battery module:
the integrated current collector is connected to a first end portion of each battery cell of the plurality of battery cells, and
the at least one layer of thermally conductive adhesive material is disposed adjacent to a second end portion of each battery cell of the plurality of battery cells, the second end portion being oppositely disposed to the first end portion.

22. (canceled)

23. The battery pack of claim 21, wherein the layer of thermally conductive adhesive material has dielectric properties.

24. (canceled)

25. The battery pack of claim 20, wherein:
for each module, the layer of thermally conductive adhesive material is a first layer of thermally conductive adhesive material; and
the battery pack further comprises:
a second layer of thermally conductive adhesive material disposed between the heat transfer plates of the plurality of battery modules and the housing body.

26. The battery pack of claim 25, wherein a position in the housing of each of the plurality of battery modules is maintained by the second layer of thermally conductive adhesive material.

27. The battery pack of claim 25, wherein the second layer of thermally conductive adhesive material includes:
a thermally conductive resin; and
a thermal conduction dopant material added to the thermally conductive resin, the thermal conduction dopant material being configured to increase thermal conductivity of the thermally conductive resin.

28. The battery pack of claim 27, wherein the thermal conduction dopant material is a metallic dopant material.

29. The battery pack of claim 20, wherein:
each battery module of the plurality of battery modules further comprises a rigid support matrix for receiving the plurality of battery cells therein; and
for each module, the layer of thermally conductive adhesive material is arranged to maintain a position of the plurality of battery cells in the rigid support matrix.

30.-34. (canceled)
